(19) United States
(12) Patent Application Publication
(10) Pub. No.: US 2025/0272407 A1
(43) Pub. Date: Aug. 28, 2025

(54) System, Method, And Device For Processing Data From Legacy Infrastructure

(71) Applicant: The Toronto-Dominion Bank, Toronto (CA)

(72) Inventors: Aayush KATHURIA, Brampton (CA); Periyakaruppan SUBBUNARAYANAN, Heidelberg (CA); Sahoo Prakash SAMAYA, Suwanee, GA (US); Ganish TOOLSIE, Brampton (CA); Srinivasan SARMAN, Oakville (CA); Matthew J. SCHINKEL, Oshawa (CA)

(73) Assignee: The Toronto-Dominion Bank, Toronto, ON (CA)

(21) Appl. No.: 18/590,370

(22) Filed: Feb. 28, 2024

(51) Int. Cl. G06F 21/57; G06F 21/62

(52) U.S. Cl. CPC G06F 21/575; G06F 21/62

(57) ABSTRACT

A device, method, and system for treating data from legacy infrastructure is disclosed. The method, illustratively, includes receiving a request to treat a data set with a treatment provider. The data set is processed by legacy architecture prior to being provided to the treatment provider. The method includes identifying whether a format of the data set is, or processing by the legacy architecture results in formats that are compatible with the treatment provider. The method includes adjusting the data set with a conversion utility to convert the data set into an adjusted data set in response to determining incompatibility with the treatment provider. The method includes providing the adjusted data set to the treatment provider for treatment.

### TECHNICAL FIELD

The following relates generally to methods of treating data from legacy infrastructure.

### BACKGROUND

Certain existing digital environments rely on dated approaches or hardware to implement digital infrastructure.

When production data is handled by the dated approaches or by hardware, issues can arise. For example, a file may come from a mainframe (MF) with complex values, but the newer infrastructure can have no means of processing the MF data file. Similarly, MF data used for a plurality of purposes can rapidly generate data of distinct types and lengths, which output data can be hard to process for siloed downstream applications. Processing production data with the dated approaches or with hardware can be difficult if the more modern infrastructure cannot accommodate outputs of the dated component.

Approaches that better (whether from a cost perspective, efficiency perspective, robustness perspective, etc.) integrate the dated approaches or hardware with more modern architecture are desirable.

### BRIEF DESCRIPTION OF THE DRAWINGS

Embodiments will now be described with reference to the appended drawings wherein:

FIG. 1 is a schematic diagram of an example computing environment.

FIG. 2 is a diagram illustrating data moving through a framework for treating data from legacy infrastructure.

FIG. 3 is a flow diagram of an example embodiment of computer executable instructions for implementing a method for treating data from legacy infrastructure.

FIG. 4 is a block diagram of an example configuration of an example device.

FIG. 5 is a block diagram of an example mainframe of an enterprise system.

### DETAILED DESCRIPTION

It will be appreciated that for simplicity and clarity of illustration, where considered appropriate, reference numerals may be repeated among the figures to indicate corresponding or analogous elements. In addition, numerous specific details are set forth to provide a thorough understanding of the example embodiments described herein. However, it will be understood by those of ordinary skill in the art that the example embodiments described herein may be practiced without these specific details. In other instances, well-known methods, procedures, and components have not been described in detail so as not to obscure the example embodiments described herein. Also, the description is not to be considered as limiting the scope of the example embodiments described herein.

The following generally relates to a framework for treating data from legacy infrastructure. A tool for interfacing between legacy architecture, such as a mainframe, and more modern applications is disclosed. Mainframes can output variable length data files, whereas more modern architectures can be constructed to work only with fixed length data files. The invention bridges this gap through a conversion utility that converts the variable length data into fixed length data. One example is that the utility converts the variable length data via padding with a specified character, resulting in a fixed length data file. The process can be reversible, and data provided to the modern architecture can be encrypted prior to transmission.

The disclosed utility can be scaled easily, be relatively efficient to implement, be implemented to avoid changing each downstream application that requires treated data, and can enable relatively robust integration between the legacy architecture and the more modern treatment processes. The disclosure includes a system that can implement the integration without sacrificing security, with the treatment provider only having access to encrypted data, and with only this encrypted data leaving the mainframe. In example embodiments, mainframe files can be masked without mainframe/ZOS environment, files with varying lengths can be treated while preserving the data structure, and file transformation can be done from local or remote servers.

In one aspect, a device for loading data into remote computing environments is disclosed. The device includes a processor, a communications module coupled to the processor, and a memory coupled to the processor. The memory stores computer executable instructions that when executed by the processor cause the processor to receive a request to treat a data set with a treatment provider. The data set is processed by legacy architecture prior to being provided to the treatment provider. The instructions cause the processor to identify when a format of the data set is incompatible with the treatment provider. The processor can, in the alternative, or in addition to assessing the format of the data set, identify when processing by the legacy architecture results in formats that are incompatible with the treatment provider. The instructions cause the processor to, in response to determining incompatibility, adjust the data set with a conversion utility to convert the data set into an adjusted data set. The instructions cause the processor to provide the adjusted data set to the treatment provider for treatment.

In example embodiments, to determine incompatibility, the computer executable instructions cause the processor to identify whether the data set comprises variable length data files. To process the data set with the conversion utility, the computer executable instructions can cause the processor to determine whether the variable length data files contain a record descriptor word, and in response to determining the presence of the record descriptor word, process the data set without a copybook.

To process the data set with the conversion utility, the computer executable instructions can cause the processor to provide a fixed length compatible with the treatment provider and adjust the data set to comply with the fixed length by padding the data set, the adjustment resulting in the adjusted data set.

In example embodiments, the computer executable instructions cause the processor to encrypt the data set prior to providing the adjusted data set to the treatment provider.

In example embodiments, the treatment comprises masking data.

In example embodiments, the treatment provider is a third-party treatment provider, and wherein to provide the adjusted data set to the treatment provider, and the computer executable instructions cause the processor to determine whether credentials provided by the treatment provider enable the treatment provider access to the adjusted data set. The computer executable instructions cause the processor to, in response to validating the credentials, transmit the adjusted data set to the treatment provider.

In example embodiments, the legacy architecture is a mainframe architecture, and the data set is a data file of a plurality of production data files.

In example embodiments, the request comprises a copybook associated with the data file, and the computer executable instructions cause the processor to generate, with a mapping utility, a modified copybook for use by the treatment provider. In example embodiments, access to the conversion utility is limited to users associated with a mainframe of the legacy architecture, and access to the mapping utility is limited to users with access to a source of the data set.

In example embodiments, the computer executable instructions cause the processor to receive treated data from the treatment provider, reverse the adjustments to the treated data, and provide the reversed treated data to a target application.

In another aspect, a method for treating data from legacy infrastructure is disclosed. The method includes receiving a request to treat a data set with a treatment provider. The data set can be processed by legacy architecture prior to being provided to the treatment provider. The method includes identifying when a format of the data set is incompatible with the treatment provider. The method can include, in the alternative, or in addition to assessing the format of the data set, identifying when processing by the legacy architecture results in formats that are compatible with the treatment provider. The method includes, in response to determining incompatibility, adjusting the data set with a conversion utility to convert the data set into an adjusted data set, and providing the adjusted data set to the treatment provider for treatment.

In example embodiments, the method includes identifying whether the data set comprises variable length data files. In example embodiments, the method can include determining whether the variable length data files contain a record descriptor word, and, in response to determining the presence of the record descriptor word, processing the data set without a copybook.

In example embodiments, the processing the data set with the conversion utility includes providing a fixed length compatible with the treatment provider and adjusting the data set to comply with the fixed length by padding the data set, the adjustment resulting in the adjusted data set.

In example embodiments, the method includes encrypting the data set prior to providing the adjusted data set to the treatment provider.

In example embodiments, the treatment provider is a third-party treatment provider, and providing the adjusted data set to the treatment provider includes determining whether credentials provided by the treatment provider enable the treatment provider access to the adjusted data set, and, in response to validating the credentials, transmitting the adjusted data set to the treatment provider.

In example embodiments, the request includes a copybook associated with the data file, and method includes generating, with a mapping utility, a modified copybook for use by the treatment provider.

In example embodiments, the method includes receiving treated data from the treatment provider, reversing the adjustments to the treated data, and providing the reversed treated data to a target application.

In another aspect, a non-transitory computer readable medium for treating data from legacy infrastructure is disclosed. The computer readable medium includes computer executable instructions for receiving a request to treat a data set with a treatment provider. The data set can be processed by legacy architecture prior to being provided to the treatment provider. The CRM is for identifying when a format of the data set is incompatible with the treatment provider. The CRM can be for, in the alternative, or in addition to assessing the format of the data set, identifying when processing by the legacy architecture results in formats that are compatible with the treatment provider. The CRM is for, in response to determining incompatibility, adjusting the data set with a conversion utility to convert the data set into an adjusted data set, and providing the adjusted data set to the treatment provider for treatment.

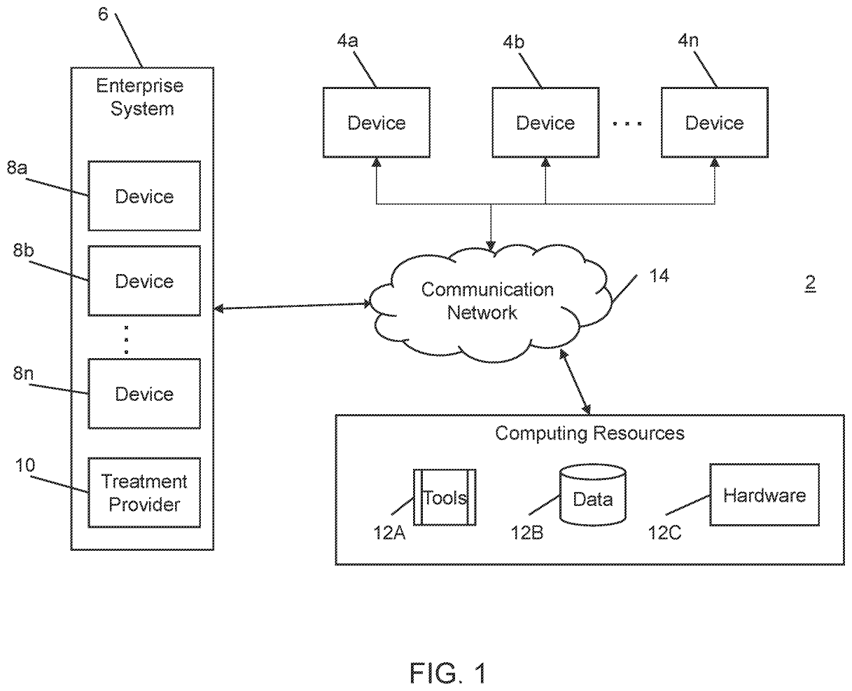

Referring now to FIG. 1, an exemplary computing environment 2 is illustrated.

In the example embodiment shown, the computing environment 2 includes an enterprise system 6, one or more devices 4 (shown as devices 4a, 4b, . . . 4n) external to the enterprise system 6, and devices 8a, 8b, to 8n, internal to the enterprise system 6.

The devices 4 external to the enterprise system 6 can be used to access functionality of the enterprise system 6 (e.g., by an employee). Devices 4 can include, but are not limited to, one or more of a personal computer, a laptop computer, a tablet computer, a notebook computer, a hand-held computer, a personal digital assistant, a portable navigation device, a mobile phone, a wearable device, a gaming device, an embedded device, a smart phone, a virtual reality device, an augmented reality device, third party portals, an automated teller machine (ATM), and any additional or alternate computing device, and may be operable to transmit and receive data across communication networks such as the communication network 14 shown by way of example in FIG. 1.

Any device 4 can be used by different users, and with different user accounts. For example, in some embodiments, the device 4 can be internal to the enterprise system 6 (not shown) and used by an employee, third party contractor, customer, etc., as can the shown external device 4. The user may be required to be authenticated prior to accessing the device 4, the device 4 can be required to be authenticated prior to accessing either the enterprise system 6 or the remote computing resources 12, or any specific accounts or resources within computing environment 2.

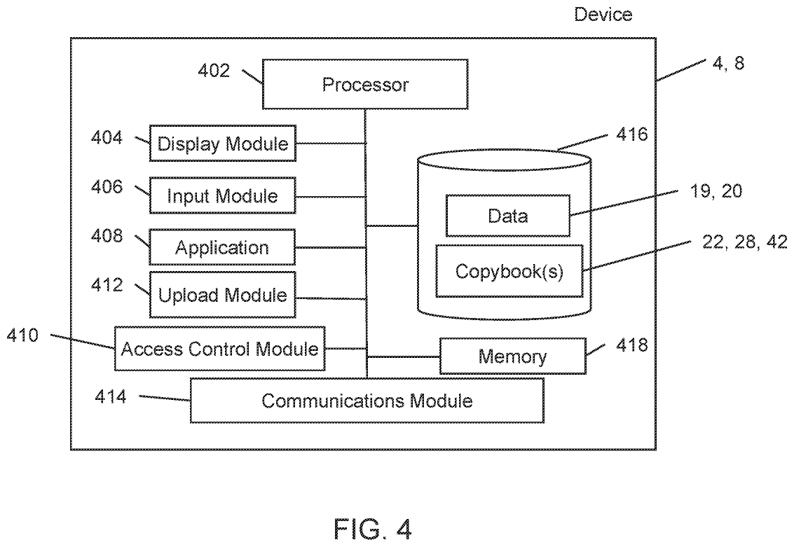

The device 4 can access information within the enterprise system 6 or remote computing resources 12 in a variety of ways. For example, the device 4 can access the enterprise system 6 via a web-based application, or a dedicated application (e.g., 408 of FIG. 4), etc. Access can require the provisioning of distinct types of credentials (e.g., login credentials, two factor authentication, etc.). In example embodiments, each different device 4 can be provided with a degree of access, or variations thereof. For example, the internal device 4 can be provided with a greater degree of access to the enterprise system 6 as compared to the external device 4.

The devices 8, internal to the enterprise system 6, can be used to implement the functionality of the enterprise system 6. For example, the device 8a can be a server for data processing at a first location, the device 8c, not shown, can be an employee computer.

The devices 8 can include legacy or dated hardware and approaches, or relatively new hardware that replaced and functions similarly to dated hardware. For example, device 8b can be a legacy mainframe device (hereinafter referred to as mainframe 8b, for ease of reference), or a new mainframe replacing the functionality of the dated mainframe. In this description, a mainframe is used to describe a relatively large and high-speed computer that supports a plurality of other devices, such as devices 8 (of devices 4, if accessing the enterprise system 6) to perform computational tasks. The mainframe 8b is specialized hardware: it is a centralized device for processing very large amounts (e.g., billions) of relatively simple calculations or transactions in real time. The mainframe 8b can (e.g., incorporate redundant internal engineering to ensure robust operations on the required scale. Mainframes 8b can run on specialized software that complements the emphasis for robustness in hardware design (e.g., software running COBOL (e.g., in certain banking or insurance applications), or specialized Linux instances, etc.). Mainframes 8b can enable a plurality of instances (e.g., operating systems) to operate at the same time. Mainframes are also important in that they enable processing of sensitive data to be controlled by an enterprise, as compared to cloud based (alternatively referred to as “multi-tenant”) computing resources.

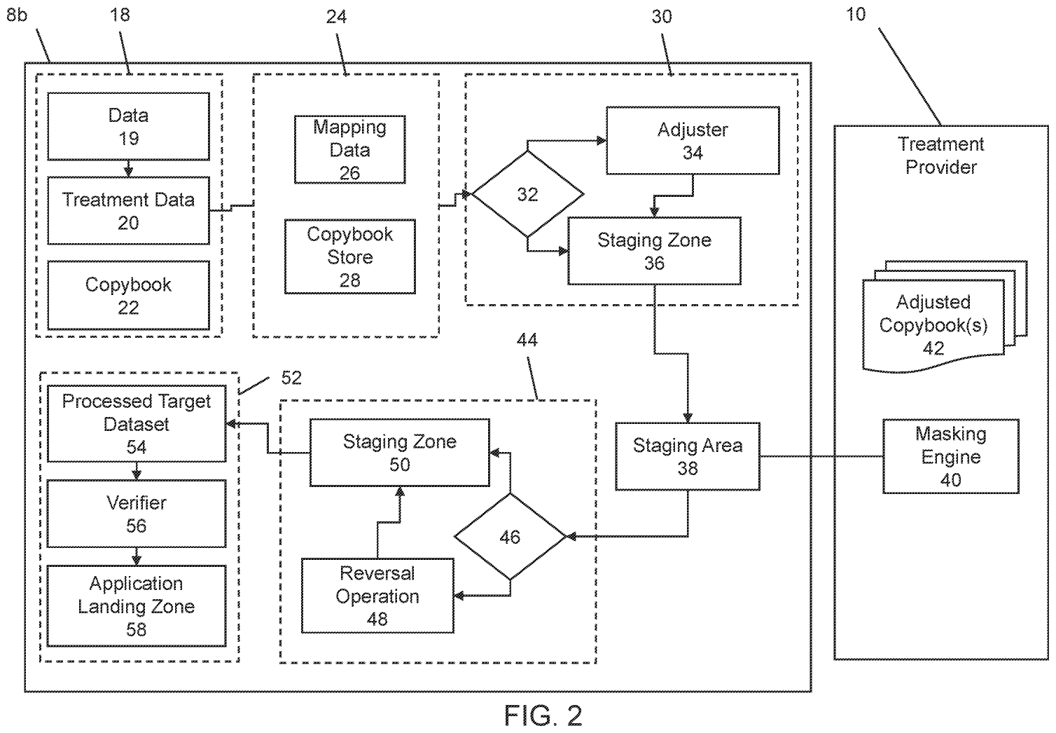

The enterprise system 6 can include a treatment provider 10. In example embodiments, not shown, the treatment provider(s) 10 are provided by a third party and accessed by the enterprise system 6. The treatment provider 10 includes at least one functionality to (1) treat data being provided to the legacy infrastructure (e.g., mainframe 8b), or to (2) treat data output from the legacy infrastructure. For example, the treatment provider 10 can include a masking engine (masking engine 40, see FIG. 2) for anonymizing data.

In example embodiments, some of the functionality of the enterprise system 6, or devices 4, 8, is implemented by remote computing resources 12. The remote computing resources 12 (hereinafter referred to in the alternative as computing resources 12) includes resources which are stored or managed by a party other than operator of the enterprise system 6 and are used by, or available to, the enterprise system 6. For example, the computing resources 12 can include cloud-based storage services (e.g., database(s) 12B). In at least some example embodiments, the computing resources 12 include one or more tools 12A developed or hosted by the external party, or tools 12A for interacting with the computing resources 12. The computing resources 12 can also include hardware resources 12C, such as access to processing capability of server devices (e.g., cloud computing), and so forth.

Each of these components of the environment 2 can be connected by a communications network 14 to one or more other components of the computing environment 2. In at least some example embodiments, all the components shown in FIG. 1 are within the enterprise system 6, and the communication network 14 is an enterprise-maintained network.

Communication network 14 may include a telephone network, cellular, and/or data communication network to connect distinct types of client devices. For example, the communication network 14 may include a private or public switched telephone network (PSTN), mobile network (e.g., code division multiple access (CDMA) network, global system for mobile communications (GSM) network, and/or any 3G, 4G, or 5G wireless carrier network, etc.), Wi-Fi or other similar wireless network, and a private and/or public wide area network (e.g., the Internet). The communication network 14 may not be required to provide connectivity within the enterprise system 6 or the computing resources 12, or between devices 4, wherein an internal or other shared network provides the necessary communications infrastructure.

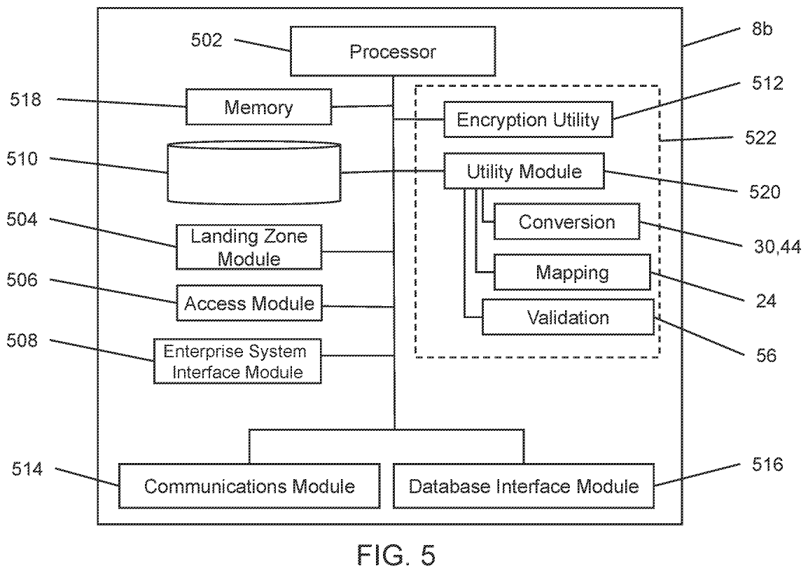

The computing environment 2 can also include a cryptographic server or module (e.g., encryption utility 512 of FIG. 5) for performing cryptographic operations and providing cryptographic services (e.g., authentication (via digital signatures), data protection (via encryption), etc.) to provide a secure interaction channel and interaction session, etc. The cryptographic module can be implemented within the enterprise system 6, or the computing resources 12, or external to the aforementioned systems, or some combination thereof. Such a cryptographic server can also be configured to communicate and operate with a cryptographic infrastructure, such as a public key infrastructure (PKI), certificate authority (CA), certificate revocation service, signing authority, key server, etc. The cryptographic server and cryptographic infrastructure can be used to protect the various data communications described herein, to secure communication channels therefor, authenticate parties, manage digital certificates for such parties, manage keys (e.g., public, and private keys in a PKI), and perform other cryptographic operations that are required or desired for particular applications carried out by the enterprise system 6 or device 4. The cryptographic server may be used to protect data within the computing environment 2 (e.g., including data stored in database(s) 12B) by way of encryption for data protection, digital signatures or message digests for data integrity, and by using digital certificates to authenticate the identity of the users and entity devices with which the enterprise system 6, computing resources 12, or the device 4 communicates, to inhibit data breaches by adversaries. It can be appreciated that various cryptographic mechanisms and protocols can be chosen and implemented to suit the constraints and requirements of the computing environment 2, as is known in the art.

The enterprise system 6 can be understood to encompass the whole of the enterprise, a subset of a wider enterprise system (not shown), such as a system serving a subsidiary or a system for a particular branch or team of the enterprise (e.g., a resource migration division of the enterprise). In at least one example embodiment, the enterprise system 6 is a financial institution system (e.g., a commercial bank) that provides financial services accounts to users and processes financial transactions associated with those financial service accounts. Such a financial institution system may provide its customers with various browser-based and mobile applications, e.g., for mobile banking, mobile investing, mortgage management, etc. Financial institutions can be responsible for vast amounts of data, and have vast amounts of existing records, both of which can rely upon legacy architecture to utilize.

Referring now to FIG. 2, a diagram illustrating data file(s) (hereinafter referred to in the plural, for ease of reference) moving through a framework for treating data from legacy infrastructure is shown. The disclosed framework may address some of the issues in the discussed existing solutions. In the embodiment shown in FIG. 2, the shown mainframe 8b is considered to be wholly on-premises, as is the treatment provider 10, solely for illustrative purposes.

The mainframe 8b can provide a zone 18 to receive or populate with sensitive data 19 (e.g., production data) that requires treatment. Access to the zone 18 can be controlled, in that only accounts with access to the sensitive data 19 can be provided with access to the zone 18. Users can, via the zone 18, request to submit some or all of the sensitive data 19 for treatment. In example embodiments, the zone 18 can be generated in response to requests for some of all of the data 19 by a downstream application or account.

To complete a request, the zone 18 can require provisioning of a copybook 22. The copybook 22 can be provided for all record types and can include a plurality of information about the data 19. For example, the copybook 22 can specify the types of data within the data 19, and properties such as whether the data is of variable or fixed length, etc. The copybook 22 can be used to generate a mapping of data 19 or metadata associated with the data 19 into a target format. For example, data 19 can have dates in a mm/dd/yyyy format and the copybook 22 can provide the conversion required to have a target format of dd/mm/yyyy. In another example, the copybook 22 can provide conversions between naming conventions in the data 19 and naming conventions or mappings to names within the target format.

Zone 18 (or a process controlling access to zone 18, or a request process that relies on zone 18, etc.) can also require the provisioning of encryption parameters prior to treatment of the data 19. For example, the encryption parameters can specify the encryption type used, values or processes (e.g., a production encryption key to use for encryption) used to implement the encryption, etc.

The zone 18 can be configured to apply encryption to the data 19, generating the treatment data 20, and to only provide the treatment data for treatment. In this way, unencrypted data 19 is never provided to the treatment provider 10, increasing security. In addition, the treatment data 20 can be curated, and include only data from the data 19 that is capable or required to be treated, increasing security.

In at least some example embodiments, the treatment provider is notified of the population of existence of the zone 18 and can pull treatment data 20 from the zone 18 for treatment.

A plurality of zones 18 can be instantiated by the mainframe 8b, to serve a plurality of applications or accounts. For example, a first mapping zone 18 can be used to treat a first type of data (e.g., credit cards), a second mapping zone (not shown) can be used to treat another type of data (e.g., bank account numbers), etc.

A mapping utility 24 is shown in FIG. 2. The mapping utility 24 can generate processing parameters 26 for incoming treatment data 20. For example, the mapping utility 24 can use mapping data to determine that the treatment datafile 20 should be processed by the conversion utility 30.

The mapping utility 24 can also generate a modified copybook within a copybook store 28 based on the processing parameters 26. For example, the mapping utility 24, after determining that the conversion utility 30 will be applied to transform incoming variable block datafiles 20 (e.g., without RDW, as that term is used herein) into fixed block data files, can generate a corresponding copybook that adjusts the copybook 22 to account for the conversion in the utility 30, and store the modified copybook in the copybook store 28.

The copybook store 28 can include a plurality of copybooks, each copybook being associated with one or more treatment datafile 20, or it can include a multi-segment copybook for use to determining which segment of the copybook applies to different data record types. In some example embodiments, the mapping utility 24 determines which existing portions of a multisegmented copybooks store 28 (e.g., the mapping utility determines that a variable to fixed block conversion is necessary, and that a copybook in the copybook store 28 applies to data from the source in from which data 19 originates) is applicable to the incoming treatment datafile 20, or which one of a plurality of copybooks in the copybook store 28 are relevant.

In example embodiments, the mapping utility 24 does not include a copybook store 28, nor is a copybook 22 required. For example, the treatment data 20 can be a variable block file with a record descriptor word (RDW) within the block, such that a copybook is not needed.

The processing parameters 26 generated by the mapping utility 24 can include one or more executables to enable transmission of the treatment data 20. For example, the processing parameters 26 can include JCL control cards that specify that certain treatment data 20 is received from a particular source, specify which operations are performed by the conversion utility 30.

A conversion utility 30 can be used to apply one or more adjustments to the treatment data 20 on the basis of the output of the mapping utility 24. For example, the treatment datafiles 20 can be variable or fixed length, and the conversion utility 30 can determine whether the file is variable length (for conversion) in block 32, apply an adjustment via an adjuster 34 to variable length blocks to generate fixed length blocks, and store generate fixed length blocks and originally fixed length blocks in a staging zone 36. The adjuster 34 can be configured to apply padding to the variable length blocks to ensure a preconfigured, fixed length. The preconfigured fixed length can be responsive to a length expected by the treatment provider 10.

In example embodiments, a plurality of treatment datafiles 20 are provided to the conversion utility 30, and the conversion utility 30 processes them in real-time or near real-time to generate the resulting fixed block data in the staging zone 36.

The conversion utility 30 and the mapping utility 24 can be access controlled. For example, in at least some contemplated example embodiments, access to the mapping utility 24 can be controlled such that any user of the enterprise system 6 can generate processing parameters 26 and copybooks for the copybooks store 28. In this way, the process of treating production data 19 can be democratized, and various applications can take advantage of the conversion utility 30. In contrast, the conversion utility 30 can be access controlled such that only certain users (e.g., CA7 NPID Users) can be granted access to initiate processing data files (e.g., batch processing). Limiting the conversion utility can promote security and robustness as only users capable of generating conversion utilities are able to initiate conversion jobs in the mainframe 8b.

In some embodiments, the separation of the mapping utility 24 and the conversion utility 30 can beneficially enable separation of the data retrieval and data processing (e.g., data is stored on a first server, and the control card is stored in a server via the mapping utility 24).

Treatment data 20 adjusted by the conversion utility 30 can be sent to a further staging zone, e.g., the shown staging zone 38. Access to the staging zone 38 is also access controlled: only certain treatment providers 10 can be enabled to retrieve data from the staging zone 38, and the channel used to transmit data can also be access controlled. For example, in the event that the treatment provider 10 is a data masking service, the staging zone 38 can be configured to provide access to only that treatment provider (e.g., Delphi), over a particular channel (e.g., an SFTP channel). The access control can also enable performance of the treatment remote to the mainframe 8b.

The treatment provider 10 receives or pulls data from the staging zone 38 for further treatment. In the shown embodiment, that treatment provider anonymizes data, and includes a masking engine 40 for masking received data. The masking can be performed based on the adjusted copybook 42 for the retrieved data, which copybook 42 can be provided from the copybook store 28. In example embodiments, the treatment provider 10 can provide a plurality of treatment services, not just the shown masking service.

Collectively, the process of retrieving production data 19 and having the data transmitted for treatment by the treatment provider 10 can be performed without the production data being exposed to unauthorized users (e.g., production data 19 is encrypted as treatment data 20) or treatment providers 10.

In example embodiments, not shown, data that is treated by the treatment provider 10 can be provided for subsequent use. For example, the treated and encrypted data can be provided to the mainframe 8b for use in analysis (e.g., after the encryption is reversed).

In embodiments where the adjustment applied by the conversion utility 30 needs to be reversed (e.g., the masked data needs to be stripped of any applied padding to convert to a fixed block), the treated data can be provided to a reversal utility 44. The reversal utility 44 can perform operations to reverse the adjustments applied, and in the shown embodiment, include determining whether the file is fixed length with adjustments (e.g., data indicates padding) in block 46, applying an adjustment to remove the padding in reversal operation 48, and storing fixed length blocks reversed into variable length blocks and originally fixed length blocks in a staging zone 50.

Access to the data processed by the reversal utility 44 can be controlled, similar to the conversion utility 30. That is, the reversal utility 44 may only be activated upon permission from a properly credentialed user to do so, which user is in example embodiments not a user acting as a steward for data being processed. In addition, only target destination(s) 52 with appropriate credentials can access the staging zone 50 to retrieve the processed data.

The processes and adjustments applied to the treatment data 20 as it progresses through the utilities can be logged for troubleshooting.

The target destination 52 can retrieve the processed data (hereinafter referred to as treated data 54, for ease of reference) from the staging zone 50, and thereafter (optionally) implement a verification 56. Verification 56 can include (automated) verification that treatment has been correctly applied. For example, in the event that the target destination 52 and the zone 18 are controlled by the same user(s), verification 56 can include a verification utility (hereinafter referred to as verification utility 56, for ease of reference) automated verification by comparison of the data 19 with the treated data 54. In example embodiments, verification can include manual verification that the correct treatment has been applied, that the treated data 54 consists of the expected amount of data, etc.

Once verified, the treated data 54 can be provided to the target destination 58, which can be a landing zone for a target application

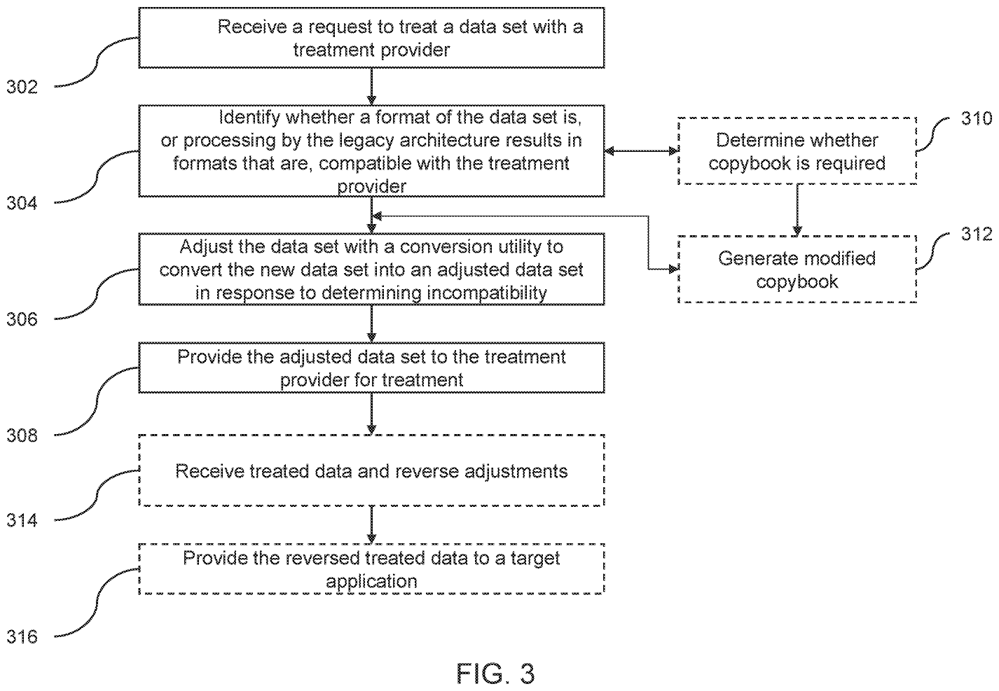

FIG. 3 is a flow diagram of an example embodiment of computer executable instructions for implementing a method for treating data from legacy infrastructure. For illustration, reference will be made to the preceding figures. It is understood that the references to the preceding figures are not intended to be limited to the embodiments described therein.

At block 302, a request to treat a data set (e.g., data 19) with a treatment provider (e.g., treatment provider 10) is received. The data set is processed by legacy architecture (e.g., mainframe 8b) prior to being provided to the treatment provider.

At block 304, whether a format of the data set (e.g., variable length data files) is, or processing by the legacy architecture results in formats (e.g., variable length data files) that are compatible with the treatment provider is identified. For example, the mapping utility 24 can determine whether the data 19 is being processed by the treatment provider 10 (e.g., based on the contents of the request of block 302), and parse the data 19 to identify whether it includes a variable length data file.

At block 306, the data set is adjusted with a conversion utility (e.g., utility 30) to convert the data set into an adjusted data (e.g., data provided to the zone 36) set in response to determining incompatibility with the treatment provider. In example embodiments, the adjustment can comprise padding variable length data files to convert same into fixed length data files with a predetermined padding character. The predetermined character can beneficially enable determination of the padding for simplifying reversal operations (e.g., the padding character is a character rarely used in the treatment data 20, allowing easy identification subsequently).

At block 308, the adjusted data from block 306 is provided to the treatment provider for treatment. Treatment can, for example, include masking, or other anonymization operations.

Optionally, at block 310, for data sets that are incompatible, the method can include determining whether a copybook is required for the operation. For example, the method can include determining whether the variable length data files contain a record descriptor word (RDW). If the data files (e.g., data 19) have RDW(s), they can be processed without a copybook. Conversely, data sets without RDW(s) can be determined to require a corresponding copybook to enable interpretation of the adjusted data by the mainframe. Moreover, as access to the mapping utility and the copybook store 28 can be public, existing users can see whether a treatment provider 10 has been used for similar data, and by viewing the processing parameters 26 and/or copybook store 28, avoid duplication by adopting the processing parameters 26 and/or copybook store 28.

Optionally, at block 312, a utility (e.g., the mapping utility 24) can generate a modified copybook for use by the conversion utility (e.g., conversion utility 30). For example, the modified copybook can include a description of how the adjustment will change the data to arrive at a fixed length data file.

Optionally, as shown in blocks 314 and 316, the adjustment applied to the data in block 306 can be reversed after treatment. Block 314 can include reversing the adjustment applied to previously variable data files (now converted fixed data files) to reverse the conversion from fixed to a variable data file again. The reversal operations can be desirable to enable integration of the treatment provider 10 with the enterprise system 6 as data without requiring changes to either service. At block 316, the reversed data can be provided to a target application (e.g., an application within the enterprise system 6).

In FIG. 4, an example configuration of a device 4, 8 (hereinafter referred to solely as device 4, for ease of reference) is shown. It can be appreciated that the device 4 shown in FIG. 4 can correspond to an actual device or represent a simulation (e.g., a virtual machine) of such a device 4. The shown device 4 can be an internal device, or an external device. The device 4 can include one or more processors 402, a communications module 414, and a data store 416 (e.g., including data for treatment, such as data 19, 20. The data store 416 can include data required to complete a request, including copybooks data, such as copybook 22, copybooks in the copybook store 28, or adjusted copybooks 42 provided to the treatment provider 10.

The data store 416 can also be used to store data, such as, but not limited to, an IP address or a MAC address that uniquely identifies device 4. The data store 416 may also be used to store data ancillary to transmitting data to the computing environment 2, such as, but not limited to, login credentials, user preferences, cryptographic data (e.g., cryptographic keys), etc.

Communications module 414 enables the device 4 to communicate with one or more other components of the computing environment 2 via a bus or other communication network, such as the communication network 14. The device 4 includes at least one memory 418 or memory device that can include a tangible and non-transitory computer-readable medium having stored therein computer programs, sets of instructions, code, or data to be executed by processor 402. FIG. 4 separately illustrates examples of modules and applications stored in memory 418 on the device 4 and operated by the processor 402. It can be appreciated that any of the modules and applications shown in FIG. 4 may also be hosted externally and be available to the device 4, e.g., via the communications module 414.

In the example embodiment shown in FIG. 4, the device 4 includes a display module 404 for rendering graphical user interfaces (GUIs) and other visual outputs on a display device such as a display screen, and an input module 406 for processing user or other inputs received at the device 4, e.g., via a touchscreen, input button, transceiver, microphone, keyboard, etc. The device 4 may also include one or more applications (shown as the singular application 408) that depend on, or otherwise use treated data (whether adjusted or having adjustment reversed). For example, the application 408 can be an application of the enterprise system 6 that uses other than production data to complete operations. The application 408 can be a web based application that serves certain data to contractors.

The device 4 may include an access control module 410 to control access to the data store 416, or data within the data store 416. For example, the access control module 410 can control whether different users of the device 4 can access the data store 416, which users have the ability to read, access, or write with data within the data store 416. In another example, the access control module 410 can be used to control transmission of data within the data store 416, such that data can only be transmitted to pre-approved zones.

The uploading module 412 enables the device 4 to, if necessary, interface with the remote computing resources 12, or a subset thereof, to transmit data for treatment.

Referring to FIG. 5, an example configuration of a mainframe 8b is shown. It can be appreciated that the mainframe 8b shown in FIG. 5 can correspond to an actual device, or represent a simulation of the functionality of a mainframe 8b, or represent a configuration of multiple servers cooperating as a mainframe. The mainframe 8b can include one or more processors 502, a communications module 514, and a data store 510 (e.g., for storing the modules, access controls, maintaining zones, etc.), and a database interface module 516.

Communications module 514 enables the mainframe 8b to communicate with one or more other components of the remote computing resources 12 or the enterprise system 6 via a bus or other communication network, such as the communication network 14. The mainframe 8b includes at least one memory 518 or memory device that can include a tangible and non-transitory computer-readable medium having stored therein computer programs, sets of instructions, code, or data to be executed by processor 502. FIG. 5 separately illustrates examples of modules and applications stored in memory 518 on the mainframe 8b and operated by the processor 502. It can be appreciated that any of the modules and applications shown in FIG. 5 may also be hosted externally and be available to the mainframe 8b, e.g., via the communications module 514.

In the example embodiment shown in FIG. 5, the mainframe 8b includes a zone module 504 for either storing data between processing steps, e.g., for generating a temporary storage to implement the staging zone 36 and/or for implementing a scheduling application to move the data between zones and other modules (e.g., the push or pull applications, or the cloud administration application).

The mainframe 8b can include an access control module 506, similar to the access control module 410. The access control module 506 can control access to utilities, control which users are able to initiate operation of the utility, or to specify changes to the utilities, etc.

The mainframe 8b may also include an enterprise system interface module 508 whose purpose is to facilitate communication with the enterprise system 6.

The mainframe 8b can include a utility store 522 to provide functionality described herein. In the shown embodiment, a separate encryption utility 512 is shown to encrypt data (e.g., data 19) prior to mapping and conversion. The encryption utility 512 can encrypt data in a variety of manners. In at least some example embodiments, data is encrypted by the encryption utility 512 in cooperation with a complementary encryption module on the device 4 or on-premises (not shown).

The utility store 522 can include a utility module 520 that includes the conversion (and, if required the reversal) utility 30, 44, the mapping utility 24, and a validation utility 56 (e.g., for automated validation).

The database interface module 516 facilitates communication with databases used to store the data (e.g., data store 510). For example, the database interface module 516 can be used to move data between zones. The data store 510 may also be used to store data ancillary to transmitting or receiving data within the computing environment 2, such as, but not limited to, login credentials, user preferences, cryptographic data (e.g., cryptographic keys), etc.

It will be appreciated that only certain modules, applications, tools, and engines are shown in FIGS. 2, 4, and 5 for ease of illustration and various other components would be provided and utilized by the device 4, enterprise system 6, and/or the remote computing resources 12, as is known in the art.

It will also be appreciated that any module or component exemplified herein that executes instructions may include or otherwise have access to computer readable media such as storage media, computer storage media, or data storage devices (removable and/or non-removable) such as, for example, magnetic disks, optical disks, or tape. Computer storage media may include volatile and non-volatile, removable, and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an application, module, or both. Any such computer storage media may be part of any of the servers or other devices in the computing environment 2, or accessible or connectable thereto. Any application or module herein described may be implemented using computer readable/executable instructions that may be stored or otherwise held by such computer readable media.

It will be appreciated that the examples and corresponding diagrams used herein are for illustrative purposes only. Different configurations and terminology can be used without departing from the principles expressed herein. For instance, components and modules can be added, deleted, modified, or arranged with differing connections without departing from these principles.

The steps or operations in the flow charts and diagrams described herein are just for example. There may be many variations to these steps or operations without departing from the principles discussed above. For instance, the steps may be performed in a differing order, or steps may be added, deleted, or modified.

Although the above principles have been described with reference to certain specific examples, various modifications thereof will be apparent to those skilled in the art as outlined in the appended claims.

1. A device for implementing a method for treating data from legacy infrastructure, the device comprising:
a processor;
a communications module coupled to the processor; and
a memory coupled to the processor, the memory storing computer executable instructions that when executed by the processor cause the processor to:
receive a request to treat a data set with a treatment provider, wherein the data set is processed by legacy architecture prior to being provided to the treatment provider;
identify when a format of the data set is incompatible with the treatment provider;
identify when processing by the legacy architecture results in formats that are incompatible with the treatment provider;
in response to determining any incompatibility, adjust the data set with a conversion utility to convert the data set into an adjusted data set; and
provide the adjusted data set to the treatment provider for treatment.

2. The device of claim 1, wherein, to determine incompatibility, the computer executable instructions cause the processor to:
identify whether the data set comprises variable length data files.

3. The device of claim 2, wherein, to process the data set with the conversion utility, the computer executable instructions cause the processor to:
determine whether the variable length data files contain a record descriptor word; and
in response to determining the record descriptor word, process the data set without a copybook.

4. The device of claim 1, wherein, to process the data set with the conversion utility, the computer executable instructions cause the processor to:
provide a fixed length compatible with the treatment provider; and
adjust the data set to comply with the fixed length by padding the data set, the adjustment resulting in the adjusted data set.

5. The device of claim 1, wherein the computer executable instructions cause the processor to:
encrypt the data set prior to providing the adjusted data set to the treatment provider.

6. The device of claim 1, wherein the treatment comprises masking data.

7. The device of claim 1, wherein the treatment provider is a third-party treatment provider, and wherein to provide the adjusted data set to the treatment provider, the computer executable instructions cause the processor to:
determine whether credentials provided by the treatment provider enable the treatment provider access to the adjusted data set; and
in response to validating the credentials, transmit the adjusted data set to the treatment provider.

8. The device of claim 1, wherein the legacy architecture is a mainframe architecture, and the data set is a data file of a plurality of production data files.

9. The device of claim 1, wherein the request comprises a copybook associated with the data set, and the computer executable instructions cause the processor to:
generate, with a mapping utility, a modified copybook for use by the treatment provider.

10. The device of claim 9, wherein access to the conversion utility is limited to users associated with a mainframe of the legacy architecture, and access to the mapping utility is limited to users with access to a source of the data set.

11. The device of claim 1, wherein the computer executable instructions cause the processor to:
receive treated data from the treatment provider;
reverse the adjustments to the treated data; and
provide the reversed treated data to a target application.

12. A method for treating data from legacy infrastructure, the method comprising:
receiving a request to treat a data set with a treatment provider, wherein the data set is processed by legacy architecture prior to being provided to the treatment provider;
identifying when a format of the data set is incompatible with the treatment provider;
identifying when processing by the legacy architecture results in formats that are incompatible with the treatment provider;
in response to determining any incompatibility, adjusting the data set with a conversion utility to convert the data set into an adjusted data set; and
providing the adjusted data set to the treatment provider for treatment.

13. The method of claim 12, further comprising:
identifying whether the data set comprises variable length data files.

14. The method of claim 13, further comprising:
determining whether the variable length data files contain a record descriptor word; and
in response to determining the record descriptor word, processing the data set without a copybook.

15. The method of claim 12, wherein processing the data set with the conversion utility comprises:
providing a fixed length compatible with the treatment provider; and
adjusting the data set to comply with the fixed length by padding the data set, the adjustment resulting in the adjusted data set.

16. The method of claim 12, further comprising:
encrypting the data set prior to providing the adjusted data set to the treatment provider.

17. The method of claim 12, wherein the treatment provider is a third-party treatment provider, and wherein providing the adjusted data set to the treatment provider comprises:
determining whether credentials provided by the treatment provider enable the treatment provider access to the adjusted data set; and
in response to validating the credentials, transmitting the adjusted data set to the treatment provider.

18. The method of claim 12, wherein the request comprises a copybook associated with the data set, and method comprises:
generating, with a mapping utility, a modified copybook for use by the treatment provider.

19. The method of claim 12, further comprising:
receiving treated data from the treatment provider;
reversing the adjustments to the treated data; and
providing the reversed treated data to a target application.

20. A non-transitory computer readable medium for treating data from legacy infrastructure, the computer readable medium comprising computer executable instructions for:
receiving a request to treat a data set with a treatment provider, wherein the data set is processed by legacy architecture prior to being provided to the treatment provider;
identifying when a format of the data set is incompatible with the treatment provider;
identifying when processing by the legacy architecture results in formats that are incompatible with the treatment provider;
in response to determining any incompatibility, adjusting the data set with a conversion utility to convert the data set into an adjusted data set; and
providing the adjusted data set to the treatment provider for treatment.
